(19) United States
(12) Patent Application Publication
(10) Pub. No.: US 2026/0085861 A1
(43) Pub. Date: Mar. 26, 2026

(54) LOW TEMPERATURE NH3 REFORMING PROCESS COUPLED TO A HEAT PUMP

(71) Applicant: BASF SE, Ludwigshafen am Rhein (DE)

(72) Inventors: Elias Christopher FREI, Ludwigshafen am Rhein (DE); Lukas MAYR, Ludwigshafen am Rhein (DE); Alexander SCHROEDER, Ludwigshafen am Rhein (DE); Matthias FELISCHAK, Ludwigshafen am Rhein (DE); Nils BOTTKE, Ludwigshafen am Rhein (DE); Marco BOSCH, Ludwigshafen am Rhein (DE); Andreas SCHWEITZER, Ludwigshafen am Rhein (DE)

(21) Appl. No.: 19/110,905

(22) PCT Filed: Sep. 15, 2023
(86) PCT No.: PCT/EP2023/075416

§ 371 Date: Mar. 12, 2025

(30) Foreign Application Priority Data
Sep. 16, 2022 (EP) 22196137.8

(51) Int. Cl. F25B 30/02

(52) U.S. Cl. CPC F25B 30/02; C01B 3/047

(57) ABSTRACT

The present invention relates to a process for transferring heat to a stream comprising NH₃, the process comprising: (i) providing a stream comprising a heat transfer medium, wherein the stream has a pressure in the range of from 1 to 100 bar(abs) and a temperature equal to or greater than 105° C.; (ii) increasing the temperature of the stream provided in (i) by transferring heat from a chemical conversion process, from a physicochemical process, or from ambient heat, or from a combination of two or more thereof, to the heat transfer medium, for obtaining a stream having a temperature in the range of from 125 to 750° C.; (iii) increasing the pressure of the stream obtained in (ii), for obtaining a compressed stream having a temperature in the range of from 50 to 800 C; (iv) providing a stream comprising NH₃, wherein the stream comprising NH₃ has a temperature in the range of from −33 to 100° C.; (v) heating the stream provided in (iv), wherein heating comprises transferring heat from the compressed stream obtained in (iii) to the stream provided in (iv), for obtaining a heated stream comprising NH₃ having a temperature in the range of from 25 to 750° C.; (vi) expanding the compressed stream obtained in (v); (vii) optionally recycling at least a portion of the stream obtained in (vi) to (i).

### TECHNICAL FIELD

The present invention relates to processes for transferring heat to a stream comprising NH₃.

### INTRODUCTION

The provision of thermal energy for endothermic processes such as ammonia cracking is cur-rently done by burning fossil fuels or by direct electric heating. Fossil fuels are often preferred to direct electric heating because of lower efficiency and hence lower costs.

Heat pumps, by smart use of electrical energy in a thermodynamic cycle, achieve the raising of the temperature level of a quantity of heat much greater than the quantity of electrical energy used. For raising the temperature level according to a Carnot cycle, the coefficient of performance (COP) is calculated according to formula I:

$${ε}_{Carnot - WP} = 1 / ( 1 - {T}_{low} / {T}_{high} ) , \qquad ( I )$$

wherein ε_{Carnot-WP} is the coefficient of performance of the Carnot cycle of the heat pump, T_{low} is the absolute temperature in Kelvin at which the heat is absorbed and T_{high} is the absolute temperature at which the heat is released. The latter temperature must be at least equal to the temperature at which the process takes place that is to be heated.

Up to now, heat pumps have been used and designed to provide heat at a maximum temperature of about 150° C. Many technically relevant processes require large amounts of heat at temperatures significantly above this value. Examples include the melting of metals, distillation processes and endothermic chemical reactions. For thermodynamic reasons, endothermic chemical reactions typically take place at high temperatures.

DE 2951188 A1 relates to a method for utilizing waste heat from endothermic processes wherein heat is initially supplied from an external heat source at a high temperature level and residual heat from the reaction is obtained at a low temperature level, wherein the low temperature residual heat is recycled to the endothermic reaction with the aid of a heat pump.

DE 3209642 A1 discloses a process heat generation plant for the joint generation of high-temperature heat and process steam.

V. Singh et al. “Investigation of new mechanical heat pump systems for heat upgrading applications” in Int. J. Energy Ress. 2018, 42, 3078-3090 discloses examples of multistage ultrahigh-temperature heat pumps with different heat transfer media that can be used in process engi-neering processes, among other applications.

In the course of converting technical processes to sustainable energy sources, it is thus desira-ble to further increase the temperature levels achieved so far by heat pumps in order to reduce the dependency on other energy sources for processes requiring heat at high temperature levels.

Accordingly, it was the object of the present invention to provide a method in which the utiliza-tion of heat such as with the aid of heat pumps is not restricted to the increased valorization of primary energy sources and in particular of sustainable energy sources or nuclear power. In particular, it was the object of the present invention to utilize heat transfer concepts for reactions involving the conversion of ammonia, and especially for ammonia reforming, wherein said heat transfer concepts involve the valorization of heat not stemming from primary energy sources, and in particular involves the valorization of waste heat or of otherwise available low temperature heat.

### DETAILED DESCRIPTION

Thus, it has surprisingly been found that heat sources at low temperatures can be used for upgrading them to usable thermal energy, whereby a coefficient of performance (COP) of greater than 1 can be achieved. In particular, it has unexpectedly been found that the use of heat pump cascades are particularly advantageous for achieving energetic efficiencies and reducing the dependency from primary energy sources, whether they be sustainable or not. Accordingly, with the appropriate choice of heat transfer media, upgrading of heat sources is possible to directly supply heat at very high temperatures, e.g. by superheated saturated steam, to provide the nec-essary temperatures in processes involving the conversion of ammonia, in particular in ammonia reforming. In particular, it has been found that the use of high temperature heat pumps al-lows electrification of said process where electrical heating is difficult to realize, and especially with a better electrical efficiency COPᵣₑₐₗ of greater than 1.

The present invention particularly relates to a process for transferring heat from a reaction of a chemical conversion process to a stream comprising NH₃, wherein the excess heat of a chemical process and/or ambient heat is used to heat a heat transfer medium. The heat transfer medium is then compressed for additionally increasing its temperature. The resulting compressed stream is then used to heat a NH₃-containing stream. Thus, the excess heat of a chemical process and/or the ambient heat is not directly used for heating NH₃ but transferred via a heat transfer medium.

Therefore, the present invention relates to a process for transferring heat to a stream comprising NH₃, the process comprising:
(i) providing a stream comprising a heat transfer medium,
   wherein the stream has a pressure in the range of from 1 to 100 bar(abs) and a temperature equal to or greater than 105° C.;
(ii) increasing the temperature of the stream provided in (i) by transferring heat from a chemical conversion process, from a physicochemical process, or from ambient heat, or from a combination of two or more thereof, to the heat transfer medium, for obtaining a stream having a temperature in the range of from 125 to 750° C.;
(iii) increasing the pressure of the stream obtained in (ii),
   for obtaining a compressed stream having a temperature in the range of from 50 to 800° C.;
(iv) providing a stream comprising NH₃, wherein the stream comprising NH₃ has a temperature in the range of from −33 to 100° C.;
(v) heating the stream provided in (iv), wherein heating comprises transferring heat from the compressed stream obtained in (iii) to the stream provided in (iv), for obtaining a heated stream comprising NH₃ having a temperature in the range of from 25 to 750° C.;
(vi) expanding the compressed stream obtained in (v);
(vii) optionally recycling at least a portion of the stream obtained in (vi) to (i).

It is preferred that the heat transfer medium is selected from the group consisting of evaporating and condensing working fluids, and supercritical working fluids, wherein preferably the heat transfer medium is water, wherein more preferably the heat transfer medium is steam.

It is preferred that the stream provided in (i) has a temperature equal to or greater than 150° C., more preferably in the range of from 200 to 550° C., more preferably in the range of from 250 to 350° C.

It is preferred that the stream provided in (i) has a pressure in the range of from 5 to 50 bar(abs), more preferably in the range of from 10 to 40 bar(abs), more preferably in the range of from 20 to 30.

It is preferred that the stream provided in (i) comprises from 0 to 1 volume-%, more preferably from 0 to 0.1 volume-%, more preferably from 0 to 0.01 volume-% of NH₃.

It is preferred that from 95 to 100 volume-%, more preferably from 99 to 100 volume-%, more preferably from 99.9 to 100 volume-%, of the stream provided in (i) consist of the heat transfer medium.

It is preferred that transferring heat according to (ii) is conducted using a heat exchanger.

It is preferred that the ambient heat which is transferred according to (ii) is heat from the environment, preferably heat from one or more or air, water, soil, and solar radiation, including combinations of two or more thereof.

It is preferred that the heat from a chemical conversion process which is transferred according to (ii) is obtained from an exothermic reaction, or wherein the heat which from a chemical conversion process is transferred according to (ii) is excess heat of the heat employed for performing an autothermal reaction or an endothermic reaction.

In case where the heat from a chemical conversion process which is transferred according to (ii) is obtained from an exothermic reaction, it is preferred that the exothermic reaction comprises one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.

In case where the heat which from a chemical conversion process is transferred according to (ii) is excess heat of the heat employed for performing an endothermic reaction, it is preferred that the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.

In case where the heat which from a chemical conversion process is transferred according to (ii) is excess heat of the heat employed for performing an autothermal reaction, it is preferred that the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₈)alkanes, more preferably (C₁-C₇)alkanes.

According to the invention it is preferred that the stream obtained in (ii) has a temperature in the range of from 25 to 750° C., more preferably in the range of from 100 to 550° C., more preferably in the range of from 150 to 300° C., more preferably in the range of from 180 to 200° C.

It is preferred that the heat from a physicochemical process which is transferred according to (ii) is obtained from exothermal changes of the state of aggregation of a chemical compound or of a material, more preferably from the condensation and solidification of a chemical compound or of a material. It is particularly preferred that the heat from a physicochemical process which is transferred according to (ii) is obtained from vapor-compression evaporation.

It is preferred that in (ii) the heat transfer medium subject is at least in part to evaporation.

It is preferred that according to (iii) a compressed stream is obtained having a pressure in the range of from 1 to 250 bar(abs), more preferably in the range of from 5 to 150 bar(abs), more preferably of from 10 to 100 bar(abs), more preferably of from 20 to 90 bar(abs) It is preferred that increasing the pressure of the stream according to (iii) is conducted using a compressor.

It is preferred that the process affords a coefficient of performance (COP) of greater than 1, more preferably of 1.1 to 4, more preferably of 1.2 to 3, more preferably of 1.2 to 2, more preferably of 1.2 to 1.5.

It is preferred that increasing the pressure of the stream according to (iii) is conducted adiabatically.

Within the meaning of the present invention, an adiabatic or isothermal change of state is to be understood as a change of state effected close to the theoretical adiabatic or isothermal process.

It is preferred that from 95 to 100 volume-%, more preferably from 99 to 100 volume-%, more preferably from 99.9 to 100 volume-%, of the stream provided in (iv) consist of NH₃.

It is preferred that the stream provided in (iv) has a temperature in the range of from −33 to 100° C., more preferably in the range of from −15 to 80° C., more preferably of from 0 to 60° C., more preferably of from 15 to 50° C., more preferably of from 25 to 40° C.

It is preferred that the stream provided in (iv) has a pressure in the range of from 1 to 100 bar(abs), more preferably in the range of from 20 to 35 bar(abs).

It is preferred that the stream provided in (iv) has a weight hourly space velocity in the range of from 200 to 20,000 h⁻¹, more preferably in the range of from 2,000 to 8,000 h⁻¹.

It is preferred that heating according to (v) comprises at least partially converting NH₃ to N₂ and H₂, wherein heating according to (v) preferably comprises converting from 1 to 100 volume-%, more preferably from 15 to 50 volume-% of NH₃.

It is preferred that according to (v) a compressed stream is obtained having a temperature in the range of from 200 to 750° C., more preferably in the range of from 300 to 550° C.

It is preferred that according to (v) a compressed stream is obtained having a pressure in the range of from 1 to 100 bar(abs), more preferably in the range of from 20 to 35 bar(abs).

It is preferred that the compressed stream obtained in (v) has the same pressure as the compressed stream obtained in (iii).

It is preferred that heating according to (v) is conducted using a heat exchanger, wherein the heat exchanger is preferably a reactor containing the stream provided in (iv), more preferably the wall of a reactor containing the stream provided in (iv).

It is preferred that according to (v) a stream comprising NH₃ is obtained having a temperature in the range of from 250 to 750° C., more preferably in the range of from 290 to 310° C.

It is preferred that according to (v) a stream comprising NH₃ is obtained having a pressure in the range of from 1 to 100 bar(abs), more preferably in the range of from 10 to 40 bar(abs).

It is preferred that expanding according to (vi) is conducted using a thermal expansion valve.

It is preferred that the expanded stream obtained in (v) has the same pressure and temperature of the stream comprising a heat transfer medium provided in (i).

It is preferred that expanding the compressed stream according to (vi) is conducted adiabatically.

It is preferred that from 1 to 100 volume-%, more preferably from 50 to 100 volume-%, of the stream obtained in (vi) are recycled to (i) according to (vii).

It is preferred that the stream obtained in (vi) is entirely recycled to (i) according to (vii).

In case where the stream obtained in (vi) is entirely recycled to (i) according to (vii), it is preferred that steps (i) to (vii) are conducted in a closed system in which the stream comprising a heat transfer medium is circulated.

According to the invention, it is preferred that the process further comprises (viii) feeding the heated stream comprising NH₃ obtained in (v) to a first reactor, for obtaining a first product stream, wherein more preferably the heat of the first product stream is employed in (ii) as at least part of the heat from a chemical conversion process which is transferred to the heat transfer medium.

In case where the process further comprises (viii) feeding the heated stream comprising NH₃ obtained in (v) to a first reactor, for obtaining a first product stream, it is preferred that the heated stream obtained in (v) is fed into the first reactor having a temperature in the range of from 200 to 750° C., more preferably in the range of from 250 to 550° C.

Furthermore and independently thereof, it is preferred that the heated stream obtained in (v) is fed into the first reactor at a gas hourly space velocity in the range of from 200 to 20,000 h⁻¹, more preferably in the range of from 400 to 4,000 h⁻¹.

Furthermore and independently thereof, it is preferred that the first product stream obtained in (viii) has a temperature in the range of from 110 to 350° C., more preferably in the range of from 160 to 250° C.

Furthermore and independently thereof, it is preferred that from 1 to 75 mol-%, more preferably from 5 to 45 mol-%, of the NH₃ comprised in the heated stream fed into the first reactor are converted to N₂ and H₂, based on 100 mol-% NH₃ comprised in the heated stream fed into the first reactor.

Furthermore and independently thereof, it is preferred that the process further comprises (ix) providing the first product stream obtained in (viii) as the stream comprising NH₃ in a subsequent process for transferring heat to a stream comprising NH₃ according to anyone of the particular and preferred embodiments of the present invention, and heating the first product stream in (v) of said subsequent process to a temperature in the range of from 200 to 750° C., more preferably in the range of from 20 to 450° C., and feeding the heated first product stream to a second reactor, for obtaining a second product stream,
wherein preferably the heat of the second product stream is employed in (ii) as at least part of the heat from a chemical conversion process which is transferred to the heat transfer medium.

In case where the process further comprises (ix) providing the first product stream obtained in (viii) as the stream comprising NH₃ in a subsequent process for transferring heat to a stream comprising NH₃, it is preferred that the first product stream is fed according to (ix) into the second reactor having a gas hourly space velocity in the range of from 350 to 20000 h⁻¹, more preferably in the range of from 400 to 4000 h⁻¹.

Furthermore and independently thereof, it is preferred that the second product stream obtained in (ix) has a temperature in the range of from 110 to 350° C., more preferably in the range of from 160 to 250° C.

Furthermore and independently thereof, it is preferred that from 1 to 50 mol-%, more preferably from 5 to 25 mol-%, of the NH₃ comprised in the first product stream fed into the second reactor are converted to N₂ and H₂, based on 100 mol-% NH₃ comprised in the heated stream fed into the first reactor.

Furthermore and independently thereof, it is preferred that the process further comprises (x) providing the second product stream obtained in (ix) as the stream comprising NH₃ in a subsequent process for transferring heat to a stream comprising NH₃ according to any one of the particular and preferred embodiments of the present invention, and heating the first product stream in (v) of said subsequent process to a temperature in the range of from 250 to 550° C., more preferably in the range of from 290 to 310° C., and feeding the heated second product stream to a third reactor, for obtaining a third product stream, wherein preferably the heat of the third product stream is employed in (ii) as at least part of the heat from a chemical conversion process which is transferred to the heat transfer medium.

In case where the process further comprises (x) providing the second product stream obtained in (ix) as the stream comprising NH₃ in a subsequent process for transferring heat to a stream comprising NH₃, it is preferred that the second product stream is fed according to (x) into the third reactor having a gas hourly space velocity in the range of from 400 to 20000 h⁻¹, more preferably in the range of from 540 to 4000 h⁻¹.

Furthermore and independently thereof, it is preferred that the third product stream obtained in (x) has a temperature in the range of from 120 to 300° C., more preferably in the range of from 170 to 235° C.

Furthermore and independently thereof, it is preferred that from 1 to 50 mol-%, more preferably from 5 to 25 mol-%, of the NH₃ comprised in the second product stream fed into the third reactor are converted to N₂ and H₂, based on 100 mol-% NH₃ comprised in the heated stream fed into the first reactor.

According to the present invention, it is preferred that the first, second, and third reactor, independently from one another, is an adiabatic reactor, an isothermal reactor, or a combination thereof.

Within the meaning of the present invention, an adiabatic or isothermal reactor is to be understood as a reactor working close to the theoretical adiabatic or isothermal process.

Furthermore, it is preferred that the first, second, and third reactor, independently from one another, is a tubular reactor.

Furthermore, it is preferred that the first, second, and third reactor, independently from one another, has a diameter in the range of from 0.5 to 5 m, more preferably in the range of from 1.5 to 2.5 m, more preferably in the range of from 1.9 to 2.1 m.

Furthermore, it is preferred that the first, second, and third reactor, independently from one another, has a length in the range of from 1.0 to 20.0 m, more preferably in the range of from 2.0 to 13.0 m, more preferably in the range of from 3.0 to 12.0 m.

According to the present invention, it is preferred that the heated stream obtained in (v) is used as fuel or co-fuel for combustion with oxygen for providing heat to an endothermic reaction.

Furthermore, it is preferred that the heated stream obtained in (v) is used as feed stream for a NH₃ reforming process.

The present invention also relates to a process for transferring heat to a stream comprising NH₃, the process comprising
(1) transferring heat to a stream comprising NH₃ according to any one of the particular and preferred embodiments of the present invention, wherein the initial stream has a temperature T₀ and the heated stream obtained has a temperature T₁, wherein T₁>T₀;
(2) transferring heat to the stream comprising NH₃ obtained in (1) according to any one of the particular and preferred embodiments of the present invention, wherein the heated stream obtained has a temperature T₂, wherein T₂>T₁.

According to the present invention, it is preferred that the process further comprises one or more subsequent sequential steps
(N) transferring heat to the stream comprising NH₃ obtained in (N−1) according to any one of the particular and preferred embodiments of the present invention, wherein the heated stream obtained has a temperature T_{N}, wherein T_{N}>T_{N-1};
wherein N is 3, or 3 and 4, or 3 to 5, 3 to 6, or 3 to 7, or 3 to 8, or 3 to 9, or 3 to 10, or 3 to 11, or 3 to 12, or 3 to 13, or 3 to 14, or 3 to 15, or 3 to 16, or 3 to 17, or 3 to 18, or 3 to 19, or 3 to 20.

In the context of the present invention, a process further comprising one or more subsequent sequential steps (N) comprises x further steps, wherein x=N−2. For example, a process wherein N is 3 further comprises one subsequent sequential step (3), i.e. after step (2). As a further example, a process wherein N is 3 to 5 comprises three subsequent sequential steps (3), (4), and (5) after step (2).

The unit bar(abs) refers to an absolute pressure wherein 1 bar equals 105 Pa.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”. Further, it is explicitly noted that the following set of embodiments is not the set of claims determining the extent of protection, but represents a suit-ably structured part of the description directed to general and preferred aspects of the present invention.
1. A process for transferring heat to a stream comprising NH₃, the process comprising:
   (i) providing a stream comprising a heat transfer medium,
      wherein the stream has a pressure in the range of from 1 to 100 bar(abs) and a temperature equal to or greater than 105° C.;
   (ii) increasing the temperature of the stream provided in (i) by transferring heat from a chemical conversion process, from a physicochemical process, or from ambient heat, or from a combination of two or more thereof, to the heat transfer medium, for obtaining a stream having a temperature in the range of from 125 to 750° C.;
   (iii) increasing the pressure of the stream obtained in (ii),
      for obtaining a compressed stream having a temperature in the range of from 50 to 800° C.:
   (iv) providing a stream comprising NH₃, wherein the stream comprising NH₃ has a temperature in the range of from −33 to 100° C.;
   (v) heating the stream provided in (iv), wherein heating comprises transferring heat from the compressed stream obtained in (iii) to the stream provided in (iv), for obtaining a heated stream comprising NH₃ having a temperature in the range of from 25 to 750° C.;
   (vi) expanding the compressed stream obtained in (v);
   (vii) optionally recycling at least a portion of the stream obtained in (vi) to (i).
2. The process of embodiment 1, wherein the heat transfer medium is selected from the group consisting of evaporating and condensing working fluids, and supercritical working fluids, wherein preferably the heat transfer medium is water, wherein more preferably the heat transfer medium is steam.
3. The process of embodiment 1 or 2, wherein the stream provided in (i) has a temperature equal to or greater than 150° C., preferably in the range of from 200 to 550° C., more preferably in the range of from 250 to 350° C.
4. The process of any one of embodiments 1 to 3, wherein the stream provided in (i) has a pressure in the range of from 5 to 50 bar(abs), preferably in the range of from 10 to 40 bar(abs), more preferably in the range of from 20 to 30.
5. The process of any one of embodiments 1 to 4, wherein the stream provided in (i) comprises from 0 to 1 volume-%, preferably from 0 to 0.1 volume-%, more preferably from 0 to 0.01 volume-% of NH₃.
6. The process of any one of embodiments 1 to 5, wherein from 95 to 100 volume-%, preferably from 99 to 100 volume-%, more preferably from 99.9 to 100 volume-%, of the stream provided in (i) consist of the heat transfer medium.
7. The process of any one of embodiments 1 to 6, wherein transferring heat according to (ii) is conducted using a heat exchanger.
8. The process of any one of embodiments 1 to 7, wherein the ambient heat which is transferred according to (ii) is heat from the environment, preferably heat from one or more or air, water, soil, and solar radiation, including combinations of two or more thereof.
9. The process of any one of embodiments 1 to 8, wherein the heat from a chemical conversion process which is transferred according to (ii) is obtained from an exothermic reaction, or wherein the heat which from a chemical conversion process is transferred according to (ii) is excess heat of the heat employed for performing an autothermal reaction or an endothermic reaction.
10. The process of embodiment 9, wherein the exothermic reaction comprises one or more of methanol production, dimethyl ether production, NH₃ production, ethylene epoxidation, sulfuric acid production, and selective oxidation of one or more of alkanes, alkenes and alkynes, preferably selective oxidation of one or more of alkanes, alkenes and alkynes to acrolein or acrylic acid.
11. The process of embodiment 9, wherein the endothermic reaction comprises one or more of steam cracking, ethane dehydrogenation, propane dehydrogenation, butane dehydrogenation, steam reforming, dry reforming, styrene production, methanol reforming, dimethyl ether reforming, reverse water-gas shift, alcohol dehydration, and NH₃ reforming.
12. The process of embodiment 9, wherein the autothermal reaction is selected from the group consisting of autothermal reforming of natural gas and hydrocarbons, including partial oxidation (POx) processes of hydrocarbons, wherein the hydrocarbons are selected from the group consisting of (C₁-C₁₀)alkanes, more preferably (C₁-C₈)alkanes, more preferably (C₁-C₇)alkanes.
13. The process of any one of embodiments 1 to 12, wherein the stream obtained in (ii) has a temperature in the range of from 25 to 750° C., preferably in the range of from 100 to 550° C., more preferably in the range of from 150 to 300° C., more preferably in the range of from 180 to 200° C.
14. The process of any one of embodiments 1 to 13, wherein the heat from a physicochemical process which is transferred according to (ii) is obtained from exothermal changes of the state of aggregation of a chemical compound or of a material, preferably from the condensation and solidification of a chemical compound or of a material.
15. The process of embodiment 14, wherein the heat from a physicochemical process which is transferred according to (ii) is obtained from vapor-compression evaporation.
16. The process of any one of embodiments 1 to 15, wherein in (ii) the heat transfer medium subject is at least in part to evaporation.
17. The process of any one of embodiments 1 to 16, wherein according to (iii) a compressed stream is obtained having a pressure in the range of from 1 to 250 bar(abs), preferably in the range of from 5 to 150 bar(abs), more preferably of from 10 to 100 bar(abs), more preferably of from 20 to 90 bar(abs)
18. The process of any one of embodiments 1 to 17, wherein increasing the pressure of the stream according to (iii) is conducted using a compressor.
19. The process of any one of embodiments 1 to 18, wherein the process affords a coefficient of performance (COP) of greater than 1, preferably of 1.1 to 4, more preferably of 1.2 to 3, more preferably of 1.2 to 2, more preferably of 1.2 to 1.5.
20. The process of any one of embodiments 1 to 19, wherein increasing the pressure of the stream according to (iii) is conducted adiabatically.
21. The process of any one of embodiments 1 to 20, wherein from 95 to 100 volume-%, preferably from 99 to 100 volume-%, more preferably from 99.9 to 100 volume-%, of the stream provided in (iv) consist of NH₃.
22. The process of any one of embodiments 1 to 21, wherein the stream provided in (iv) has a temperature in the range of from −33 to 100° C., preferably in the range of from −15 to 80° C., more preferably of from 0 to 60° C., more preferably of from 15 to 50° C., more preferably of from 25 to 40° C.
23. The process of any one of embodiments 1 to 22, wherein the stream provided in (iv) has a pressure in the range of from 1 to 100 bar(abs), preferably in the range of from 20 to 35 bar(abs).
24. The process of any one of embodiments 1 to 23, wherein the stream provided in (iv) has a weight hourly space velocity in the range of from 200 to 20,000 h⁻¹, preferably in the range of from 2,000 to 8,000 h⁻¹.
25. The process of any one of embodiments 1 to 24, wherein heating according to (v) comprises at least partially converting NH₃ to N₂ and H₂, wherein heating according to (v) preferably comprises converting from 1 to 100 volume-%, preferably from 15 to 50 volume-% of NH₃.
26. The process of any one of embodiments 1 to 25, wherein according to (v) a compressed stream is obtained having a temperature in the range of from 200 to 750° C., preferably in the range of from 300 to 550° C.
27. The process of any one of embodiments 1 to 26, wherein according to (v) a compressed stream is obtained having a pressure in the range of from 1 to 100 bar(abs), preferably in the range of from 20 to 35 bar(abs).
28. The process of any one of embodiments 1 to 27, wherein the compressed stream obtained in (v) has the same pressure as the compressed stream obtained in (iii).
29. The process of any one of embodiments 1 to 28, wherein heating according to (v) is conducted using a heat exchanger, wherein the heat exchanger is preferably a reactor containing the stream provided in (iv), more preferably the wall of a reactor containing the stream provided in (iv).
30. The process of any one of embodiments 1 to 29, wherein according to (v) a stream comprising NH₃ is obtained having a temperature in the range of from 250 to 750° C., preferably in the range of from 290 to 310° C.
31. The process of any one of embodiments 1 to 30, wherein according to (v) a stream comprising NH₃ is obtained having a pressure in the range of from 1 to 100 bar(abs), preferably in the range of from 10 to 40 bar(abs).
32. The process of any one of embodiments 1 to 31, wherein expanding according to (vi) is conducted using a thermal expansion valve.
33. The process of any one of embodiments 1 to 32, wherein the expanded stream obtained in (v) has the same pressure and temperature of the stream comprising a heat transfer medium provided in (i).
34. The process of any one of embodiments 1 to 33, wherein expanding the compressed stream according to (vi) is conducted adiabatically.
35. The process of any one of embodiments 1 to 34, wherein from 1 to 100 volume-%, preferably from 50 to 100 volume-%, of the stream obtained in (vi) are recycled to (i) according to (vii).
36. The process of any one of embodiments 1 to 35, wherein the stream obtained in (vi) is entirely recycled to (i) according to (vii).
37. The process of embodiment 36, wherein steps (i) to (vii) are conducted in a closed system in which the stream comprising a heat transfer medium is circulated.
38. The process of any one of embodiments 1 to 37, wherein the process further comprises (viii) feeding the heated stream comprising NH₃ obtained in (v) to a first reactor, for obtaining a first product stream, wherein preferably the heat of the first product stream is employed in (ii) as at least part of the heat from a chemical conversion process which is transferred to the heat transfer medium.
39. The process of embodiment 38, wherein the heated stream obtained in (v) is fed into the first reactor having a temperature in the range of from 200 to 750° C., preferably in the range of from 250 to 550° C.
40. The process of embodiment 38 or 39, wherein the heated stream obtained in (v) is fed into the first reactor at a gas hourly space velocity in the range of from 200 to 20,000 h⁻¹, preferably in the range of from 400 to 4,000 h⁻¹.
41. The process of any one of embodiments 38 to 40, wherein the first product stream obtained in (viii) has a temperature in the range of from 110 to 350° C., preferably in the range of from 160 to 250° C.
42. The process of any one of embodiments 38 to 41, wherein from 1 to 75 mol-%, preferably from 5 to 45 mol-%, of the NH₃ comprised in the heated stream fed into the first reactor are converted to N₂ and H₂, based on 100 mol-% NH₃ comprised in the heated stream fed into the first reactor.
43. The process of any one of embodiments 38 to 42, wherein the process further comprises (ix) providing the first product stream obtained in (viii) as the stream comprising NH₃ in a subsequent process for transferring heat to a stream comprising NH₃ according to any of embodiments 1 to 42, 57, and 58, and heating the first product stream in (v) of said subsequent process to a temperature in the range of from 200 to 750° C., preferably in the range of from 20 to 450° C., and feeding the heated first product stream to a second reactor, for obtaining a second product stream,
   wherein preferably the heat of the second product stream is employed in (ii) as at least part of the heat from a chemical conversion process which is transferred to the heat transfer medium.
44. The process of embodiment 43, wherein the first product stream is fed according to (ix) into the second reactor having a gas hourly space velocity in the range of from 350 to 20000 h⁻¹, preferably in the range of from 400 to 4000 h⁻¹.
45. The process of embodiment 43 or 44, wherein the second product stream obtained in (ix) has a temperature in the range of from 110 to 350° C., preferably in the range of from 160 to 250° C.
46. The process of any one of embodiments 43 to 45, wherein from 1 to 50 mol-%, preferably from 5 to 25 mol-%, of the NH₃ comprised in the first product stream fed into the second reactor are converted to N₂ and H₂, based on 100 mol-% NH₃ comprised in the heated stream fed into the first reactor.
47. The process of any one of embodiments 43 to 46, wherein the process further comprises (x) providing the second product stream obtained in (ix) as the stream comprising NH₃ in a subsequent process for transferring heat to a stream comprising NH₃ according to any of embodiments 1 to 42, 57, and 58, and heating the first product stream in (v) of said subsequent process to a temperature in the range of from 250 to 550° C., preferably in the range of from 290 to 310° C., and feeding the heated second product stream to a third reactor, for obtaining a third product stream, wherein preferably the heat of the third product stream is employed in (ii) as at least part of the heat from a chemical conversion process which is transferred to the heat transfer medium.
48. The process of embodiment 47, the second product stream is fed according to (x) into the third reactor having a gas hourly space velocity in the range of from 400 to 20000 h⁻¹, preferably in the range of from 540 to 4000 h⁻¹.
49. The process of any one of embodiments 47 or 48, wherein the third product stream obtained in (x) has a temperature in the range of from 120 to 300° C., preferably in the range of from 170 to 235° C.
50. The process of any one of embodiments 47 to 49, wherein from 1 to 50 mol-%, preferably from 5 to 25 mol-%, of the NH₃ comprised in the second product stream fed into the third reactor are converted to N₂ and H₂, based on 100 mol-% NH₃ comprised in the heated stream fed into the first reactor.
51. The process of any one of embodiments 38 to 50, wherein the first, second, and third reactor, independently from one another, is an adiabatic reactor, an isothermal reactor, or a combination thereof.
52. The process of any one of embodiments 38 to 51, wherein the first, second, and third reactor, independently from one another, is a tubular reactor.
53. The process of any one of embodiments 38 to 52, wherein the first, second, and third reactor, independently from one another, has a diameter in the range of from 0.5 to 5 m, preferably in the range of from 1.5 to 2.5 m, more preferably in the range of from 1.9 to 2.1 m.
54. The process of any one of embodiments 38 to 53, wherein the first, second, and third reactor, independently from one another, has a length in the range of from 1.0 to 20.0 m, preferably in the range of from 2.0 to 13.0 m, more preferably in the range of from 3 to 12 m.
55. The process of any one of embodiments 1 to 54, wherein the heated stream obtained in (v) is used as fuel or co-fuel for combustion with oxygen for providing heat to an endothermic reaction.
56. The process of any one of embodiments 1 to 55, wherein the heated stream obtained in (v) is used as feed stream for a NH₃ reforming process.
57. A process for transferring heat to a stream comprising NH₃, the process comprising
   (1) transferring heat to a stream comprising NH₃ according to any one of embodiments 1 to 42, wherein the initial stream has a temperature T₀ and the heated stream obtained has a temperature T₁, wherein T₁>T₀;
   (2) transferring heat to the stream comprising NH₃ obtained in (1) according to any one of embodiments 1 to 42, wherein the heated stream obtained has a temperature T₂, wherein T₂>T₁.
58. The process of embodiment 57, the process further comprising one or more subsequent sequential steps
   (N) transferring heat to the stream comprising NH₃ obtained in (N−1) according to any one of embodiments 1 to 42, wherein the heated stream obtained has a temperature T_{N}, wherein T_{N}>T_{N-1};
   wherein N is 3, or 3 and 4, or 3 to 5, 3 to 6, or 3 to 7, or 3 to 8, or 3 to 9, or 3 to 10, or 3 to 11, or 3 to 12, or 3 to 13, or 3 to 14, or 3 to 15, or 3 to 16, or 3 to 17, or 3 to 18, or 3 to 19, or 3 to 20.

The present invention is further illustrated by the following reference examples, examples and comparative examples.

### EXAMPLES

The following examples were simulated using conventional software.

### Example 1: NH₃ Vaporization and Pre-Heating with a Coupled Heat Pump

The hot outlet of a heat pump is used to vaporize and pre-heat a NH₃-containing stream for further processing. Table 1 below shows the relevant power consumption values. For a treatment of a NH₃-containing stream without subsequent NH₃ reforming step, a coefficient of performance (COP) value of 4.0 or 1.3, thus well above 1, can be obtained. It depends if the heat pump is solely used for the evaporation step or for the pre-heating as well.

TABLE 1
Data for the pre-heating of a NH₃-containing
stream using a heat pump for heat supply.

| | evaporation | Heating to 250° C. |
|---|---|---|
| NH₃ stream | 10 t/h | 10 t/h |
| heat flow for NH₃ | 3.8 MW/1.0 MW | — |
| evaporation/electric | | |
| power consumption | | |
| of heat pump | | |
| Heating from 20° C. | — | 1.3 MW/1.0 MW |
| to 250° C./electric | | |
| power consumption | | |
| of heat pump | | |
| COP | 4.0 | 1.3 |

### Example 2: NH₃ Reforming Reaction in an Adiabatic Reactor Coupled to a Heat Pump

The pre-heated NH₃-containing gas stream created according to Example 1 is used for a NH₃ reforming process in an adiabatic reactor. In this case the inlet temperature is fixed to 300° C. The NH₃-containing gas stream was set to 10 t/h as reference scenario and the adiabatic reactor had a fixed geometry of 2 m of diameter and 10 m of length. Table 2 shows the inlet and outlet temperature, the NH₃ conversion and GHSV. FIG. 1 shows the conversion, temperature and equilibrium values.

TABLE 2
Temperature, NH₃ conversion and GHSV
of an adiabatic reactor concept

| | Temp. | Temp. | | GHSV, |
|---|---|---|---|---|
| | in, ° C. | out, ° C. | Conversion, % | h⁻¹ |
| Adiabatic reactor | 300 | 167.7 | 11.4 | 419 |

### Example 3: NH₃ Reforming Reaction in a Cascade of Adiabatic Reactors Coupled to a Heat Pump

The pre-heated NH₃-containing gas stream created according to Example 1 was used for a NH₃ reforming process with a cascade of adiabatic reactors. In this case the inlet temperature was fixed to 300° C. for each reactor. The NH₃-containing gas stream was set to 10 t/h as reference scenario in the first adiabatic reactor. The outlet stream of the first adiabatic reactor was heated again to 300° C. and fed to the second adiabatic reactor. The outlet stream of the second adiabatic reactor was heated again to 300° C. and fed to the third adiabatic reactor. Each adiabatic reactor had a fixed geometry of 2 m of diameter and 10 m of length. Table 3 shows the inlet and outlet temperature, the NH₃ conversion and GHSV. FIG. 2 shows the conversion, temperature and equilibrium values.

TABLE 3
Temperature, NH₃ conversion and GHSV
of three adiabatic reactors in a row

| | Temp. | Temp. | | GHSV, |
|---|---|---|---|---|
| | in, ° C. | out, ° C. | Conversion, % | h⁻¹ |
| 1^{st} adiabatic | 300 | 167.7 | 11.4 | 419 |
| reactor | | | | |
| 2^{nd} adiabatic | 300 | 180.6 | 22.1* | 511 |
| reactor | | | | |
| 3^{rd} adiabatic | 300 | 189.1 | 32.4* | 554 |
| reactor | | | | |

*accumulated

### Example 4: NH₃ Reforming Reaction in a Quasi-Isothermal Reactor Coupled to Heat Pump

The pre-heated NH₃-containing gas stream created according to Example 1 was used for a NH₃ reforming process within a quasi-isothermal reactor concept. Thus, the NH₃-containing gas stream having a temperature of 300° C. steam was used as heat source for an endothermic NH₃ reforming process. Table 4 shows the corresponding conversion values of NH₃ and inlet/outlet temperatures. The reactor had a fixed geometry of 2 m diameter and 10 m of length. The heat flux for the quasi-isothermal process concept was adjusted to 170 W/m²/K.

TABLE 4
Temperature, NH₃ conversion and GHSV
of a quasi-isothermal reactor

| | Temp. | Temp. | | GHSV, |
|---|---|---|---|---|
| | in, ° C. | out, ° C. | Conversion, % | h⁻¹ |
| Quasi-isothermal | 300 | 216.1 | 18.3 | 419 |
| reactor | | | | |

### Example 5: NH₃ Reforming Reaction with Two Adiabatic Reactors and One Quasi-Isothermal Reactors in Series Coupled to a Heat Pump

### a) Reactor Set-Up and NH₃ Conversion

The pre-heated NH₃-containing gas stream created according to Example 1 is used for a NH₃ reforming process with a cascade of two adiabatic reactors followed by one quasi-isothermal reactor. In this case the inlet temperature was fixed to 300° C. for each reactor. The NH₃-containing gas stream was set to 10 t/h as reference scenario in the first adiabatic reactor. The outlet of the first adiabatic reactor was heated again to 300° C. and fed to the second adiabatic reactor. All reactors had a fixed geometry of 2 m of diameter and 10 m of length. The heat flux for the quasi-isothermal reactor was adjusted to 170 W/m²/K. Table 5 shows the inlet and outlet temperature, the NH₃ conversion and GHSV. FIG. 4 shows the conversion, temperature and equilibrium values.

TABLE 5
Temperature, NH₃ conversion and GHSV of two adiabatic
reactors and one quasi-isothermal reactor in a row

| | Temp. | Temp. | | GHSV, |
|---|---|---|---|---|
| | in, ° C. | out, ° C. | Conversion, % | h⁻¹ |
| 1^{st} adiabatic | 300 | 167.7 | 11.4 | 419 |
| reactor | | | | |
| 2^{nd} adiabatic | 300 | 180.6 | 22.1* | 511 |
| reactor | | | | |
| 3^{rd} quasi- | 300 | 227.4 | 37.6* | 576 |
| isothermal | | | | |
| reactor | | | | |

*accumulated

b) COP-Value of the Heat Pump System with 300° C. Reactor Inlet

The influence of the heat pump integration according to Example 5 was calculated. Table 6 shows the energetic values finally leading to a COP-value of 1.2. This means, the NH₃ reforming process is 20% more efficient when applying the heat pump concept, in comparison to a direct usage of electric power to heat the reactors.

TABLE 6
COP-value of the heat pump system coupled
to a dedicated NH₃ conversion scenario

| NH₃ stream | 10 t/h |
|---|---|
| Heat flow for 37.6% | 2.8 MW |
| NH₃ conversion | |
| Electric power | 2.3 MW |
| consumption | |
| COP-value | 1.2 |

### Cited Literature

DE 2951188 A1
DE 3209642 A1
V. Singh et al. “Investigation of new mechanical heat pump systems for heat upgrading applications” in Int. J. Energy Ress. 2018, 42, 3078-3090

1.-15. (canceled)

16. A process for transferring heat to a stream comprising NH₃, the process comprising:
(i) providing a stream comprising a heat transfer medium,
wherein the stream has a pressure in the range of from 1 to 100 bar(abs) and a temperature equal to or greater than 105° C.;
(ii) increasing the temperature of the stream provided in (i) by transferring heat from a chemical conversion process, from a physicochemical process, or from ambient heat, or from a combination of two or more thereof, to the heat transfer medium, for obtaining a stream having a temperature in the range of from 125 to 750° C.;
(iii) increasing the pressure of the stream obtained in (ii),
for obtaining a compressed stream having a temperature in the range of from 50 to 800° C.;
(iv) providing a stream comprising NH₃, wherein the stream comprising NH₃ has a temperature in the range of from −33 to 100° C.;
(v) heating the stream provided in (iv), wherein heating comprises transferring heat from the compressed stream obtained in (iii) to the stream provided in (iv), for obtaining a heated stream comprising NH₃ having a temperature in the range of from 25 to 750° C.;
(vi) expanding the compressed stream obtained in (v); and
(vii) optionally recycling at least a portion of the stream obtained in (vi) to (i).

17. The process of claim 16, wherein the heat transfer medium is selected from the group consisting of evaporating and condensing working fluids, and supercritical working fluids.

18. The process of claim 16, wherein transferring heat according to (ii) is conducted using a heat exchanger.

19. The process of claim 16, wherein the ambient heat which is transferred according to (ii) is heat from the environment.

20. The process of claim 16, wherein the heat from a chemical conversion process which is transferred according to (ii) is obtained from an exothermic reaction, or wherein the heat which from a chemical conversion process is transferred according to (ii) is excess heat of the heat employed for performing an autothermal reaction or an endothermic reaction.

21. The process of claim 16, wherein the heat from a physicochemical process which is transferred according to (ii) is obtained from exothermal changes of the state of aggregation of a chemical compound or of a material.

22. The process of claim 21, wherein the heat from a physicochemical process which is transferred according to (ii) is obtained from vapor-compression evaporation.

23. The process of claim 16, wherein increasing the pressure of the stream according to (iii) is conducted using a compressor.

24. The process of claim 16, wherein the process affords a coefficient of performance (COP) of greater than 1.

25. The process of claim 16, wherein increasing the pressure of the stream according to (iii) is conducted adiabatically.

26. The process of claim 16, wherein expanding the compressed stream according to (vi) is conducted adiabatically.

27. The process of claim 16, wherein the process further comprises
(viii) feeding the heated stream comprising NH₃ obtained in (v) to a first reactor, for obtaining a first product stream.

28. The process of claim 16, wherein the process further comprises
(viii) feeding the heated stream comprising NH₃ obtained in (v) to a first reactor, for obtaining a first product stream; and
(ix) providing the first product stream obtained in (viii) as the stream comprising NH₃ in a subsequent process for transferring heat to a stream comprising NH₃ according to claim 16, and heating the first product stream in (v) of said subsequent process to a temperature in the range of from 200 to 750° C., and feeding the heated first product stream to a second reactor, for obtaining a second product stream.

29. The process of claim 16, wherein the process further comprises
(viii) feeding the heated stream comprising NH₃ obtained in (v) to a first reactor, for obtaining a first product stream;
(ix) providing the first product stream obtained in (viii) as the stream comprising NH₃ in a subsequent process for transferring heat to a stream comprising NH₃ according to claim 16, and heating the first product stream in (v) of said subsequent process to a temperature in the range of from 200 to 750° C., and feeding the heated first product stream to a second reactor, for obtaining a second product stream; and
(x) providing the second product stream obtained in (ix) as the stream comprising NH₃ in a subsequent process for transferring heat to a stream comprising NH₃ according to claim 16, and heating the first product stream in (v) of said subsequent process to a temperature in the range of from 250 to 550° C., and feeding the heated second product stream to a third reactor, for obtaining a third product stream.

30. A process for transferring heat to a stream comprising NH₃, the process comprising
(1) transferring heat to a stream comprising NH₃ according to claim 16, wherein the initial stream has a temperature T₀ and the heated stream obtained has a temperature T₁, wherein T₁>T₀; and
(2) transferring heat to the stream comprising NH₃ obtained in (1) according to claim 16, wherein the heated stream obtained has a temperature T₂, wherein T₂>T₁.
